(19) United States
(12) Patent Application Publication
(10) Pub. No.: US 2015/0304375 A1
(43) Pub. Date: Oct. 22, 2015

(54) METHOD AND SYSTEM FOR COORDINATING THE REPRODUCTION OF USER SELECTED AUDIO OR VIDEO CONTENT DURING A TELEPHONE CALL

(71) Applicant: TALKMUSICALLY LIMITED, Ripley, Surrrey (GB)

(72) Inventor: Narinder DHILLON, Southall Middlesex (GB)

(21) Appl. No.: 14/377,400

(22) PCT Filed: Feb. 6, 2013
(86) PCT No.: PCT/GB2013/050273

§ 371 Date: Aug. 7, 2014

(30) Foreign Application Priority Data
Feb. 7, 2012 (GB) 1202120.0

(51) Int. Cl. H04L 29/06

(52) U.S. Cl. CPC H04L 65/4007; H04L 65/1089; H04L 65/602

(57) ABSTRACT

A method and system are described for establishing a telephone call between a caller terminal and a call recipient terminal, in which user-selected audio or video content is transmitted during the call in addition to any spoken audio or captured video data of the caller and call recipient. The user selected audio or video may for example be an audio music track, a video music track, or other audio or video content, such as live or prerecorded broadcast content. A call initiator can select a contact to call, and can select audio or video content to exchange on the call. The audio or video content can be played back during the call in a number of transmission modes, such as background in which the call data happens simultaneously in tandem with the audio- or video playback, or in switch mode, in which only one of the call or the audio or video data is playing at a time.

The invention relates to a method and system for coordinating the reproduction of user selected audio or video (AV) content as part of a telephone call, such that the AV content can be experienced by at least two parties to the call in synchronisation, and in particular where the AV content is music.

Present day mobile communication devices such as mobile telephones or smartphones are provided with powerful internal computer processors and memories for storing the necessary operating software, user applications and data. The operating software is usually provided by the communication device manufacturer or communication network operator to perform all essential operations, such as placing and receiving telephone calls, storing and looking up contact information, keeping time and date information and appointments. Further functionality may be provided by the communication device manufacturer or communication network operator, such as software for downloading and playing games, or for downloading and playing AV content, such as music tracks and video data.

User applications are additional programs or software developed by separate parties and which are intended to supplement the preinstalled basic functionality of the mobile communication device. The market for user applications is increasing as such devices are provided with bigger and better processors and memory functions, and as mobile communication bandwidth increases.

A number of operating system applications and user applications already exist for playback of music and video data. These applications typically allow a user to upload music or video to the mobile communication device, through connection to a personal computer for example, and to download data from an external source such as a commercial music provider, often for a fee or in exchange for display of an advertisement. Downloaded data may be then be stored on the mobile communication device for later playback. Alternatively, data may be streamed to the mobile communication device for immediate playback. Such data is often not stored on the device, or is stored only for a short time while playback occurs and is automatically deleted afterwards.

Many user applications also allow a user to share data with another user over a communication network. Sharing in this context typically involves uploading a link to the data onto a community based server. By accessing the link, other parties can connect to the data and download it or view it themselves. Such systems however require both the party sharing the data, and those who wish to access the data to be members of the community. Sharing in this context therefore remains an single user experience in which a party individually accesses common data and subsequently feeds back usually by text on a community comment page. This means that the sharing of data is not in fact an integrated real time experience in which multiple parties can interact with one another, but is instead simply a collection of sequential single user responses occurring over a protracted period of time following the data being made available.

We have therefore appreciated that it would be desirable to provide a mechanism for sharing AV content in real time between at least two users, such that commentary and feedback is available immediately.

### SUMMARY OF THE INVENTION

The invention is defined in the independent claims to which reference should now be made. Advantageous features are set forth in the dependent claims.

In one aspect of the invention, a computer implemented method is provided for establishing a telephone call between a caller terminal and a call recipient terminal, in which user-selected audio or video content is transmitted during the call in addition to any spoken audio or captured video data of the caller and call recipient. The method comprises: a) selecting a call recipient, and audio or video content for transmission during a call; b) initiating a call to the selected call recipient terminal over a call network; c) receiving data representing the caller's voice; d) receiving audio or video data representative of the selected audio or video content; e) preparing, at a synchroniser in the caller terminal, the received data of the caller's voice and selected audio or video content into data packets for transmission; and f) transmitting to the call recipient the data packets of the caller's voice and selected audio or video data.

The synchroniser processes any audio or video data that relates to the verbal or visual communication between the caller and call recipient, as well as the selected audio or video content that is to be exchanged between the parties, and thereby facilitates transmission of the two data types over the call channel.

In a further aspect of the invention, the method provides a background transmission mode, in which the synchroniser combines the received data of the caller's voice and selected audio or video content into packets for transmission, such that both the caller's voice and selected audio or video content are output for simultaneous playback at the call recipient terminal. This allows the selected audio or video content to play in the background while the call is taking place.

Advantageously, the synchroniser may select, in dependence on the caller's voice data and the selected audio and video content, a compression scheme for the caller's voice data and a compression scheme for the selected audio or video content. This allows the music to be transmitted at a higher quality when there is little or no voice data of the caller and call recipient to include in the transmission.

In a further aspect of the invention, the method provides a switch transmission mode, in which the synchroniser processes the received data of the caller's voice and selected audio or video content into packets for transmission, such that only one output of the selected audio or video content or the caller's voice data is being played back at any time.

This allows the caller rand caller recipient to switch between the call and the content that is being shared without the selected audio or video content being a distraction to the call itself. The switching may occur manually when the caller or caller recipient activate a button on a user interface, or automatically when the synchroniser or mobile terminal detects that the caller or call recipient are speaking.

Advantageously, the synchroniser may transmit the data of the caller's voice and the selected audio or video content in separate data packets to one another. This means that less compression is required for the audio or video content allowing it to be transmitted at a higher quality.

In a further aspect of the invention, the method comprises receiving at the caller terminal a user selection of a transmission mode, wherein transmission modes include a background transmission mode in which both the caller's voice and the selected audio or video content are combined for simultaneous playback, and a switch transmission mode in which the caller's voice and the selected audio or video content is interleaved for alternating playback; and passing the user selection of a transmission mode to the synchroniser in the user terminal. In this way, the transmission mode can be made user selectable, allowing for user preference, and increasing flexibility in the content exchange.

The method may comprise transmitting control signals to the caller recipient terminal to control the initiated call between the caller terminal and the caller recipient terminal. In one aspect, the control signal may cause the call recipient terminal to launch a software application. This allows the caller to cause the call recipient's terminal to launch the same calling user application as is running on the caller's terminal, so that both caller and call recipient can enjoy the same level of functionality in the call. Other software applications could also be launched, such as media players or web browsers.

The method may comprise receiving at the synchroniser in the caller terminal a control signal from the call recipient terminal. This allows the call initiator terminal to receive input during a call from the call recipient terminal, meaning both caller and call recipient have the option of controlling the call.

In one aspect, the control signal can indicate a permission status over the transmission of the user selected audio or video content. In one example, in response to the permission status indicated by the control signal, the synchroniser in the caller terminal can accept pause or play requests for the selected audio or video content from the call recipient terminal. In another example, the synchroniser in the caller terminal can accept requests from the call recipient terminal for different user selected audio or video content.

In practice, the network may be a data network, such as a network that implements the Voice Over Internet Protocol (VOIP), or a cellular network.

The user selected audio or video data may be a pre-recorded music clip or video clip, such as but not limited to MPEG or MP3 encoded files. It may also be live-streamed audio or video data received from a broadcaster.

A corresponding computer program, computer and mobile terminal are also provided.

### BRIEF DESCRIPTION OF THE DRAWINGS

Examples of the invention will now be explained, by way of example only, and with reference to the drawings in which:

FIG. 1 is a schematic illustration of an example mobile communications terminal on which a user application for performing the invention is installed;

FIG. 2 is a schematic illustration of a communications network;

FIG. 3 is a schematic illustration of an on screen user interface;

FIG. 4 is a schematic flowchart illustrating example functional steps of the user application;

FIG. 5 is a more detailed diagram illustrating the operation of the synchroniser when transmitting data;

FIG. 6 is a more detailed diagram illustrating the operation of the synchroniser in a receiving mode; and

FIG. 7 is a schematic illustration of an example system in an alternative example of the invention.

### DETAILED DESCRIPTION

Examples of the invention will now be described for the purposes of illustration only. In a first example, the invention is provided in the form of software for operation on a mobile telephone device. The software allows the user of the mobile telephone device (the caller or call originator) to place a call to another telephone user (the callee or call recipient), and to control the streaming of music content to the other telephone user while the call is taking place. Both the audio data making up the telephone call, and the music content are therefore synchronised, and streamed accordingly as a music sharing call. As will be explained later, in other examples, the music content may be general audio content, or audio/video content. The software may be provided as a user application as will be described below.

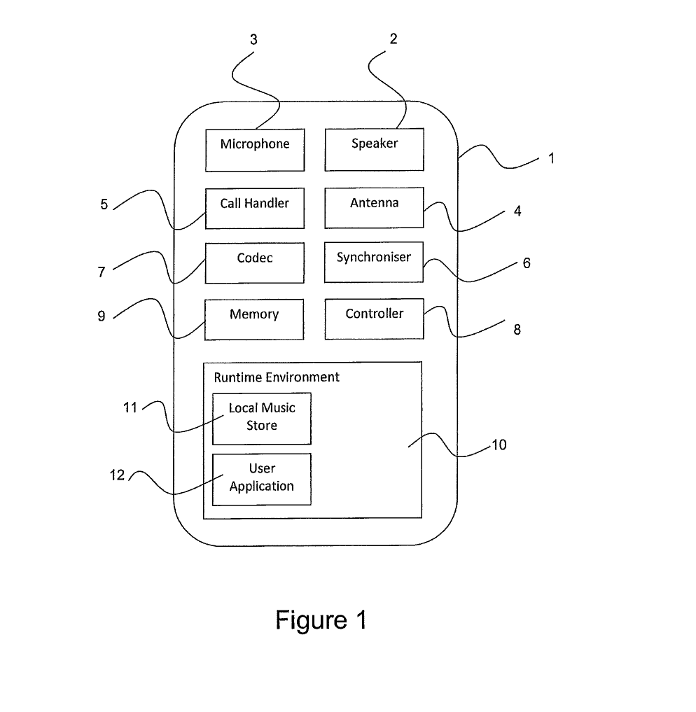

FIG. 1 is a schematic illustration of a mobile telephone device. The mobile telephone device comprises a handset 1 in which a speaker 2 and microphone 3 are provided for playing back and recording sound. The handset further comprises an antenna 4 for transmitting and receiving data signals via a telecommunications network, such as the 3G network (or other generations, lower or higher) or WiFi, as well as a call handler 5, a synchroniser 6, and an encoder/decoder (codec) 7 for encoding audio or video data for transmission and decoding received data. In operation, the codec 7 passes an encoded byte stream of data to the synchroniser 6, and in turn receives encoded byte streams of data from the synchroniser 6. As will be described later, the synchroniser 6 is responsible for handling music data received from the codec 7 and voice data received from the microphone 3 and mixing these into data that can be transmitted over the network to another mobile device.

When receiving calls, the synchroniser 6 is also responsible for separating music and voice data in the incoming call data, routing the voice data to the speaker 2, and routing the music data to the codec 7. From the codec 7 the decoded music data is then also sent to the speaker.

When transmitting calls, the synchroniser is responsible for preparing the music and voice data for transmission across the network. It also sends only the music data received from the codec to the speaker so that the user of the phone hears the music they have selected for inclusion in the call without their voice also being output.

It will be appreciated that the voice data received from the microphone 3 will also be subject to compression/decompression and encoding and decoding. This can either be handled in the codec 7, the microphone itself 3, or the synchroniser 6. In the examples that follow, the codec 7 will largely be referred to as encoding and decoding the music data.

The mobile telecommunication device also includes a controller 8 for controlling phone functions, including the speaker 2 and microphone 3, call handler 5 and synchroniser 6, codec 7 and antenna 4, as well as a memory 9 for storing operating system software, user applications and system and user data. In this context the memory 9 can include both Read Only Memory and Random Access Memory. The controller 8 may comprises one or more computer processors.

It will be understood that the mobile telecommunications device also includes the various usual components and peripheral features of such devices, such as a screen, a keyboard (either provided on the handset as physical buttons, displayed on screen by a keyboard controller, or both), a power supply such as a battery or wired power lead, one or more input ports for connecting the device to external hardware, such as another computer, personal digital assistant, games console, or memory device. These are equally all operated under the control of the controller 8 running operating software stored in the memory.

The controller and operating system software stored in memory provide a runtime environment 10 that enables a user to interact with the mobile telephone device and carry out its usual functions. Via the runtime environment 10, the mobile telephone device may also run user applications providing additional functionality that is not part of the original software system, as well as access specially reserved sections of the memory.

In the present case, it is assumed that the runtime environment 10 has access to a music store 11 provided in memory, in which a number of music content files are stored. A common format for such files is the MP3 format for example. These content files correspond to files that the user has made available on the phone for playback via an already installed media player. They may therefore be installed on the phone by a user uploading them onto the mobile phone device from other sources such as a memory stick, personal computer connection, or separate media player. They may also have been downloaded onto the mobile telecommunication device by a user purchasing the content from a provider website, using an internet browser provided in the runtime environment.

In this example, the functionality of the invention is provided in the form of a user application 12 installed in memory of the phone, as well as at least one or more additional components such as the synchroniser 6. The user application 12 once run by the controller 8 cooperates with the functionality of the mobile phone to place a telephone call and facilitate the streaming of music content to the other telephone user while the call is taking place. The user application 12 therefore has access to the music store 11, as well as to optional other sources of music data. As will be known to those skilled in the art, the user application can be pre-installed on the mobile telephone device by the device manufacturer or communications network provider, downloaded using a mobile internet browser from an online store of applications, or uploaded to the mobile telecommunication device directly via direct connection. Music may also be available over a data network, obviating the need for the local store, as will be explained below.

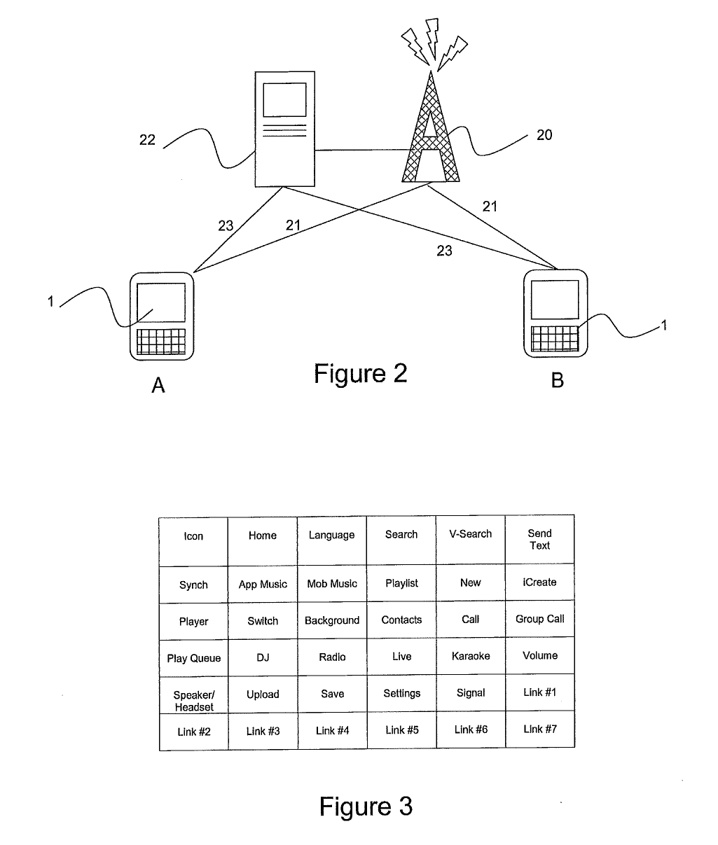

FIG. 2 illustrates a communications network in which the user application of the invention may operate. Mobile communications terminals A and B are assumed to be functionally equivalent to that discussed in FIG. 1, and capable of communicating with one another via base stations 20 of radio communication network 21 (such as the 3G data network, or other generations, with lower or higher designation), or via a wire or wireless connection to a public data network 23, such as the internet. A server 22 is also provided to handle back end support for the user applications running on mobile communication terminals A and B. The remote server stores 22 user application data, necessary for managing user accounts, as well as storing or providing access to content libraries, in particular music content. Although only two parties to a caller are shown in FIG. 2, the invention may include calls between any number of parties.

FIG. 3 illustrates, by way of example only, an example user interface that is provided on the screen of the mobile telecommunications device once the user application is initiated. The user interface is comprised of a number of buttons, each of which corresponds to an associated function. For touch screen applications, it is assumed that a user interacts with the buttons simply by touching the screen at the location of the button, either with a finger, pen or other pointing device. For non-touch screen applications, the buttons could be activated simply by using a cursor to highlight the appropriate button in conjunction with some other selection indication, such as a button or tracking ball depress, or by activating a dedicated button on the keypad. In FIG. 3, the buttons illustrated are Icon. Home, Language, Search, V-Search, Send Text, Synch, App Music, Mob Music, Playlist, New, Create, Player, Switch, Background, Contacts, Call, Group Call, Play Queue, DJ, Radio, Live, Karaoke, Volume, Speaker/Headset, Upload, Save, Settings, Signal, as well as Link #1, Link #2, Link #3, Link #4, Link #5, Link #6, and Link #7. The function of many of these buttons is self evident. Further, the buttons shown here are purely for illustration and are not intended to be limiting. The operation of a number of the buttons will be described below.

The Icon button is used to display an icon symbolic of the running application. The button may therefore serve a branding function, or if activated may take the user (from a sub-level menu) to a home screen displaying top level functionality, to an about screen, or even to a webpage.

The link buttons in particular are intended to allow the user application to link to the functionality provided by other proprietary content sharing user applications such as Shazam™, You Tube™, Spotify™, Facebook™, and Twitter™ for example.

Many of the buttons listed above have self-explanatory functions that allow a user to carry out control related to the discovery and playback of music data. Several of the buttons however have particular functions which particularly relate to facilitating the operation of the call and of sharing the music. These buttons are Switch. Background, and Synch, and will be described in more detail later.

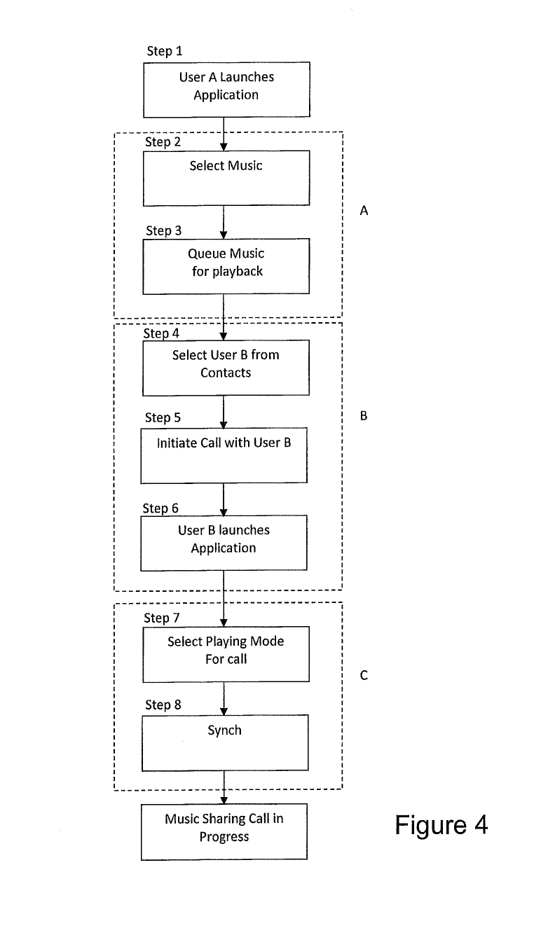

The mode of operation to conduct a synchronised voice and music call will now be described with reference to FIG. 4.

In step 1, the user of a first mobile communication terminal (User A) launches the user application. Doing so brings up the user interface of FIG. 3 on the screen of the terminal. The interface provides user A with a number of options for handling the components of the shared music call. As shown in steps 2 and 3, one of the necessary components of the call is a selection of the music that will be played. The user application provides a number of different functions for selecting music and making this available for the call. These functions correspond also to the music source from which the music is available.

For example, pressing the App Music button displays on the screen of the mobile terminal, all music files that are available via the user application and stored on the remote server. These music files need not therefore be permanently stored on the mobile communications handset, as they are made available to the mobile communications terminal during the call session over the public data network. In this capacity, the remote server acts like a cloud based music library. The music files on the remote server may be owned by the user, for example where the user has uploaded music that they own to the remote server. This may be achieved using the Upload button for example to transfer music files from the mobile terminal to the remote server. Alternatively, music files may be made available via the remote server for purchase and download, or in a streaming format for instantaneous use without recording privileges being available.

Pressing the Mobile Music button on the other hand, displays on the screen of the mobile terminal, all music files that the user has stored in the memory of the mobile communications terminal. Such music files will likely have been uploaded from another music playback device, such as a portable MP3 player or a personal computer.

Music tracks may also be available to the user application via third party websites, such as Youtube™, Spotify™, & Last.fm™. Buttons Link #1 to #7 for example provide short-cut access to such websites for the user.

Lastly, music may also be accessed using the Search or V-Search (voice search) functions. Using these functions allows the user to input searching criteria into the mobile terminal for comparison against available music tracks. The input data may correspond to textual or spoken representations of an artist or track name, as well as indication of when or where the track was used (such as on television advertisements). Music recognition software, such as that provided by Shazam™, can also be provided allowing a user to search for music by humming or singing an extract from the song.

Selecting playback of any of a music file from any of these sources of music allows the user to add the music file to a queue for playback during the shared music call. In step 2, the user therefore browses through the various music sources that are available and selects music tracks for use during the call. The user application obtains the music track from the remote server, memory or third party website as appropriate and in step 3 queues the music for the call. In this context, queuing can mean downloading the music file to a cache or storing the reference to the music source for later access. One or more music files may be queued in this way, in a playback order selected by the user. Playback of the queued music will not however begin until the play button is pressed or a music sharing call is started and music sharing is commenced.

Having selected the music for the call, the user in Step 4 then uses the Contacts button to display a list of call recipients. The user may be automatically prompted to select a contact if they indicate that the music selection stage is over. Two forms of contact exist, those who have installed the user application onto their mobile communication terminal, and those who have not, but are known to user as a regular contact stored in their phone book. The contacts listed in the user application function encompass both types, and where necessary the regular contacts will need to be imported. Having selected user B from the contact list, the user (user A) then presses the Call button to initiate the call with user B.

A call is then made to user B from the user application of the mobile communications device. In this example, in Step 5 the call originates under the instruction of the user application rather than any calling software provided in the operating system of the mobile communication terminal. The user application may include a dedicated call handler 5 in order to achieve this or may take control of the operating system call handler instead.

The call handler 5 opens a channel to the user B's mobile communication terminal in the normal way. This is achieved using a Voice Over Internet Protocol (VOIP) session for transmission over the public data network, or alternatively VOIP over the data part of the 3G system. The technology for achieving voice calls over data networks is well known, and will not be described further here.

At this point, user B receives an incoming call transmission on their mobile communication terminal and can accept the call and begin speaking to user A. A signal is also sent from mobile communication terminal A to mobile terminal communication terminal B to indicate the call is a music sharing call. This signal prompts user B in Step 6 to open the user application on their mobile terminal if this has already been installed. If the application has not yet been installed, user B is provided with a prompt for downloading the user application. The signal transmitted to user B from User A's mobile communication device requests a response. If user B launches the user application on their mobile communication terminal, then the mobile communication terminal A is notified that user B is now participating in the music sharing call. This is achieved in a straight forward way by the user application on the mobile communication terminal of user B transmitting an acknowledgement signal in reply to user A. If user B declines to open the user application, or declines to download the application, then user A is notified accordingly by user B's mobile terminal (in practice this response can be the absence of an acknowledgement reply to the signal, or a dedicated signal). Refusing to open the application will mean that user B will not be able to participate actively in the music sharing call, but that they may however choose to receive the music sharing call as a standard call in a VOIP data call, if such functionality is installed on their mobile terminal. An example of such call functionality is Skype™. In this case, some of the music sharing call functionality will no longer be available to the call originator user A (such as the Switch mode described below, although background mode will still be possible), User B they may receive the music sharing call simply as an incoming data stream, and will be able to reply simply with voice data or video data.

Once a call is in place, user A can choose in Step 7 how to incorporate the music part of the call into the call. Two options are provided, namely Background and Switch. Once playback of the queued music has begun, background mode plays the music continuously in the background while users A and users B are permitted to speak over the top. The background mode can operate as the default setting. The volume of the music relative to the voice data that is audible to user A and B can further be controlled by the users during the music sharing call using the Volume buttons provided in the user interface. For example user B may turn the music volume up or down relative to user A's voice to suit his personal tastes. This volume control will not affect the volume of the music that is audible to user A, who will be able to set the volume of music to user B's voice independently for their own mobile communications terminal.

In the Switch mode, the mobile communication terminal detects when a user begins speaking and pauses playback of the music. The terminal also waits for a pre-determined time after a user has finished speaking before automatically commencing playback. The predetermined length of time is set to be a little longer than the time interval usually left by parties in a conversation between respective lines of speech. In this way, the music playback fits around the parties' conversation, and is silenced (while continuing to play on mute) or paused when the parties speak. The user may easily switch between background mode and switch mode during a call by pressing one or more dedicated buttons on the handset. Suitable options include the asterisk or star button ‘#’, and the pound or hash button ‘#’ for example. A further Karaoke playback mode is described below.

During playback of an active music sharing call, the parties may also control playback using the Player function provided in the user application. When a music sharing call is not in progress, the player function simply controls the playback of a music track via the application in the normal way, providing play, pause, fast forward, rewind, and skip options for control. Once a music sharing call is underway however, use of the playback function controls the music track being listened to by both parties. In the first instance, control of playback will belong to user A, the party who originated the call. Using control setting preferences or buttons on the playback interface, user A can however set the level of cooperative control enjoyed by party B. For example, User A may allow User B one or more of the following:

i) “No Control” over the playback of the music track, in which case all of the user B's playback functionality is disabled;

ii) “Limited Control” over the playback of the music track, in which case, User B is provided with limited functionality, such as Pause and Play, while all other playback functionality is disabled;

iii) “Deferred Control” over the playback of the music track, in which case, User B has full access to playback functionality but controls that are above those listed in the limited control option must first be authorised by user A. In this case, if user B wishes to skip to the next track, user B can physically ask user A to skip forward, or can hit the ‘skip’ button on their player. In this case, user A receives a request to skip forward, which can easily be authorised.

iv) “Cooperative control” in which both parties have equal authorisation to control the playback of the music;

v) “Transferred Control” in which user A transfers full control to user B, for example when there are a number of users and user A wishes to leave a call that they had originated. In this mode, the user selects a user who will then take over the master control for playback of the music track.

The user application also provides a Synch button to control the playback of the audio track between the parties. Pressing the Synch button in Step 8 ensures that the music track that is playing on the mobile terminal of user A is playing on the terminal of user B and that the two terminals are in synchronisation. The button therefore shares functionality with the ‘play’ button, but essentially results in playback on all devices that are party to the music sharing call. If any text data is to be included in the music sharing call and displayed along with the playback of the audio, such as lyrics or user entered text, the Synch button also allows a zero point for timing purposes to be defined.

Including text data in the music sharing call is made straightforward by use of the Sync button. Text can be synchronised for display during the music sharing call by entering a string of text that is to be appear on screen, and entering the time at which the entered text string should be displayed. This function can be useful for happy birthday messages or other celebratory communications.

### Operation

The operation of the user application and its interaction with the mobile terminal and data network will now be explained in more detail. As discussed above, the user application synchronises both human speech and music data at the mobile terminal of FIG. 1 and subsequently transports both data sources over the network transport layer to the mobile terminal of another user.

The user application controls the mobile terminal microphone such that any data received from the microphone (speech data from the user) is passed to the synchroniser ready for encoding as the voice element of the call.

As illustrated in FIG. 1, the user application also makes use of codec player to read the music byte stream from the selected music source. Ways in which the music source can be selected for playback are described above. The data output from the codec (representing the selected music playback) is also passed as a byte stream to the synchronizer. The music that is played back is also passed to speaker so that the user can hear the music that they have selected.

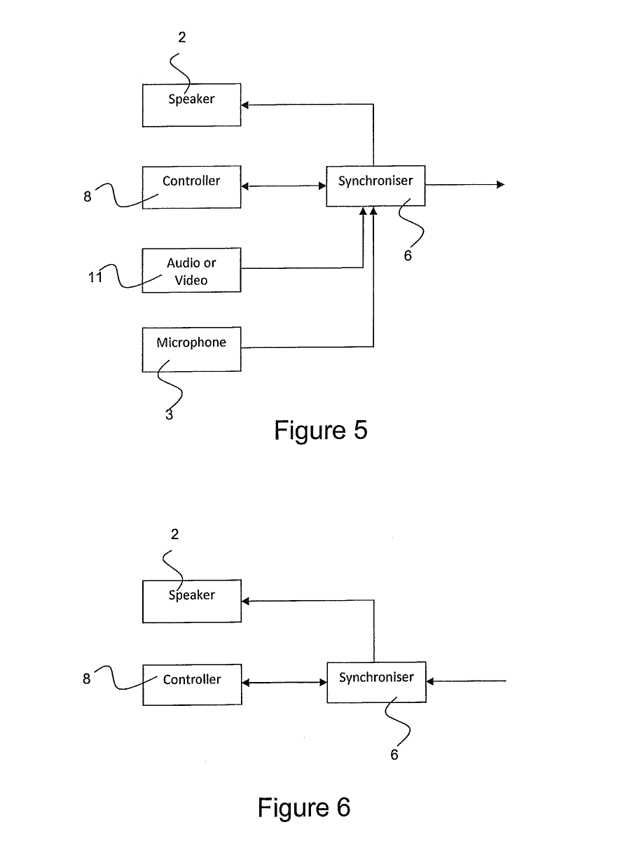

FIG. 5 illustrates in more detail the transmission of data from the synchroniser 6.

The synchronizer 6 processes the voice received from the microphone 3 and the music stream 11 received from the codec ready for transmission, and prepares packets of data for transmission over the Transport Control Protocol to the receiving terminal. In the background mode of operation for example, both voice and user selected audio or video content may be processed and packaged inside the same packets. In this mode of operation, the synchroniser samples the voice and the audio or video data at different rates, to determine the bit rate at which the two kinds of data should be encoded in the data packets for transmission. The sampling frequency used in the synchroniser may for example make use of adaptive multi rate mechanism to synchronize voice and music. This means that when the caller and call recipient are not speaking on the call, the synchroniser 6 can prioritise the sharing of the user-selected audio or video content, providing more space in the data packet being encoded for transmission of the user selected audio or video data, and less for the transmission of the voice data. Once either of the caller and the call recipient begin to speak, the adaptive rate mechanism can then allocate more space within the data packet being encoded to allow voice data to be included. Alternatively, the synchroniser 6 can choose to allocate single data packets that are to be encoded exclusively to one of either the caller and call recipient call voice data, or the user selected audio or video content. In this case, the rate at which data packets exclusively containing voice data, and data packets exclusively containing the user selected audio or video data are transmitted, between the caller terminal and the call recipient terminal, is varied depending on the content of the data being received at the synchroniser 6. When the synchroniser is operating in switch mode, sending the voice and the user selected audio or video data in separate packets allows implementation to be achieved more easily. The synchroniser determines from its input whether voice data from the microphone 3 is being received and, if it is, the data received from the codec is cached for later encoding and only voice packets are then encoded and transmitted.

As shown in FIG. 5 the synchroniser also sends the data packets containing the user-selected audio or video content to the speaker (or to a screen for video data) for playback to the user of the terminal. If the data packets are prepared to contain only audio or video data (without the call's voice or image) then only those packets are transmitted to the speaker (or screen). If the data is mixed in single packets for transmission, then the synchroniser sends the stream of audio or video data it received for transmission to the speaker 3 or screen).

The synchroniser can also act to transmit the control data between the caller and the call recipient and vice versa. Control information can be transmitted between both parties by including control data bytes in the header of the data packets. These bytes, when received by the user runtime environment 10 of the other terminal, may act to pause, play, stop, skip, rewind, or fastforward the playback of the user selected audio or video content, select different audio or video content for playback, change volume, change transmission modes, or call control permissions. A control byte encoded in the header of a data packet may also be used to launch the runtime environment 10 on the caller recipient terminal from the caller terminal. Synchroniser 6 communicates with controller 8 in order to change settings according to the user input and received control data from another terminal.

The combined data stream of voice and music data is passed to the call handler for transmission via the antenna to the call recipient. The call handler's function is to establish a channel with the user across the data or mobile phone network. As is known in the art, in a data network the channel may be established using communication protocols such as the VOIP protocol. The call handler also acts to receive the voice data from the call recipient and play this back at the speaker to the user.

When communication occurs via a data network, the call handler causes the data output from the synchroniser to be sent over the data transport layer to the call recipient's mobile terminal. It will be appreciated that the data received at the call recipient's mobile terminal will therefore be a combined stream of the user's voice and any music track that is being played back. In switch mode, it will be one or the other of the voice or music data.

FIG. 6 illustrates the situation where the synchroniser 6 of the caller terminal is receiving data from the call recipient. In this case, the call recipient has taken control of the call and transmitted both voice and user-selected audio or video data to the caller. The synchroniser 6 receives data via the transport control protocol, and passes this to the speaker 2 for playback. As before, control signals may be exchanged between the controller 8 and the synchroniser.

If the call recipient does not have the user application installed on their device, then they will simply receive a call with both voice and music tracks present (playing simultaneously in background mode or alternating in switch mode). They will still therefore be able to listen to the music sharing call, but will only be able to participate in control or selection of the music if they launch the user application. Where the user application calls a landline, the music sharing call can therefore still be listened to providing the public telephone network has a decoder installed at the switch for converting the encoded music sharing call to a regular telephone signal.

As discussed above, data communication signals between the mobile terminal devices are sent in the usual way over the data network or mobile phone communication network. This allows the joint control of the music playback to be carried out.

In the switch mode of operation, the controller monitors the data received at the microphone to determine if the user is speaking. If the user is not speaking then the data from the microphone is cached but is not sent to the call handler. A data flag is also set so that the synchroniser knows there is no voice data to include at the present time, and includes only the music data in the data stream. The data flag can be used so that the synchroniser reallocates the channel bandwidth normally reserved for voice communication to the music playback when no voice data is received from the microphone.

In switch mode, the controller analyses the signal from the microphone as well as any cached microphone signal to determine when the user has begun to speak, and signals the synchroniser to reintroduce the voice data into the data stream being transmitted on the channel. The cached microphone data is therefore useful as it can avoid any chopping or loss of the voice signal at the moment the signal is reintroduced. In other words, the cached data can be used to capture any useful voice signal that occurs before the controller has detected that speech is occurring so that this can be added back into the voice signal for transmission. It will be appreciated that such data will only likely occupy a few milliseconds of time, otherwise the delay in the speech signal would be detectable. Historic cached microphone data can therefore be discarded after a second or two as new data is fed into the cache.

In this example, the synchroniser is located in the mobile terminal. In alternative embodiments however, the synchroniser and call handler may be located at the server. In this way the data would be processed at the server and streamed to both parties mobile terminals, rather than processes in the terminal of one of the parties and streamed to the other.

### Alternatives

In the example described above, the user application first establishes a channel, so that voice communication with the callee can take place, and subsequently chooses a playback mode for the music that has been selected in earlier steps of the method. As a result, the music sharing part of the call begins after voice communication has already begun. This is a helpful mode of operation as it allows a caller to select the music before the call takes place, to introduce themselves to the caller before the music begins, and then to begin music playback at an appropriate time.

It will be appreciated however that the initially established channel has capacity to accommodate both the voice and the music playback part of the call. In alternative embodiments, therefore, the music sharing aspect of the call could begin simultaneously with the voice call (removing the need to press the Synch button, as the Synchronisation would be established by the time point marking the beginning of the call). It will also be appreciated that the user need not select the music for playback before the call begins, but could perform this function while the call is already proceeding. The functional blocks A, B and C shown in FIG. 4 can therefore occur in a different order to those shown in the diagram. Any order is in fact possible.

Certain steps of the method may also be omitted. For example, the user may already be playing music on their mobile terminal before the music sharing call is initiated. In this case, the music is queued in step 3, but playback has already occurred and there is no need to hit the Synch button to begin separate playback during the call. Also, a default playback mode (background or switch) may also be provided, so that the user need only operate these buttons when desiring to change the mode of playback.

As well as default functions, other functions may be configured to occur automatically in line with the purpose of the user application and any user preferences. For example, once music is queued ready for playback, or once the playback button is pressed, the user may be prompted to select a user contact from the contacts menu so that a music sharing call can begin.

A further playback mode, in addition to background or switch, is karaoke mode. In this mode, it is necessary that the music sharing call include visual data in addition to the voice and audio exchange between the users, so that at the very least the lyrics of the song can be displayed on screen. The visual data text may be represented in a low data rate format, such as simply ASCII or Unicode character representation of the lyrics, or in a higher data rate format, such as a video images intended for display in the background and in which the lyrics are also displayed.

In background mode, karaoke mode causes playback of a music track without lead vocals allowing the users to add their voices over the backing music. In switch mode, the mobile terminal switches between a music track with a lead vocal and a corresponding music track without lead vocal based on a detection of whether the caller or callee are singing along. The song can be paused using the buttons on the player if desired.

In the above examples the term mobile telephone device is intended to include at least mobile telephones or smartphones, as well as other mobile devices enabled with a telephone functionality. Such devices may include mobile computing devices, personal digital assistants, games consoles, and media players. The user application could also operate on devices that are not mobile, such as home computers, internet enabled televisions, and games consoles, as well as home entertainment systems, or in devices installed in automobiles or other vehicles.

Also, in the above examples, the pre-recorded audio or video (AV) content is music data stored in memory either on the mobile telephone device, or in another location such as on a separate computing device, music player or portable memory device. The pre-recorded audio or video data need not be limited to commercially recorded persistent content and so can be any audio or video content accessible by a user, such as personally recorded content, or content that is available via a streaming service. In this context, the audio or video data could therefore be persistent or transient. Where the user selected audio or video data is in fact video data, then in both background and switch modes this may be displayed in separate windows to any window in which the call is taking place. This allows video calls to be run simultaneously as the display of the user selected video content.

The term pre-recorded audio or video content is also intended to include essentially live audio or video content, which having been recorded at a location separate to the user of the mobile telephone device, is subsequently made available via a streaming service.

The term telephone call is intended to include methods of transmission between two or more parties in which at least two of the parties can be remote from one another and in which data representing their voices or even their images is exchanged electronically over wired or wireless links.

Although the invention has been described as streaming data over a single channel, it will be appreciated that in practice the synchroniser could also uses dual channels and stream the call data and the user selected audio or video data over separate channels.

In an alternative example, the invention facilitates the sharing of music over a telephone call by having callers dial into a conference server responsible for merging the calls and allowing selection of music tracks for playback. This embodiment does not require a smart phone or mobile terminal to operate, though smart or mobile phones can be advantageously used in conjunction with an application running on the phone which provides extra functionality for the call.

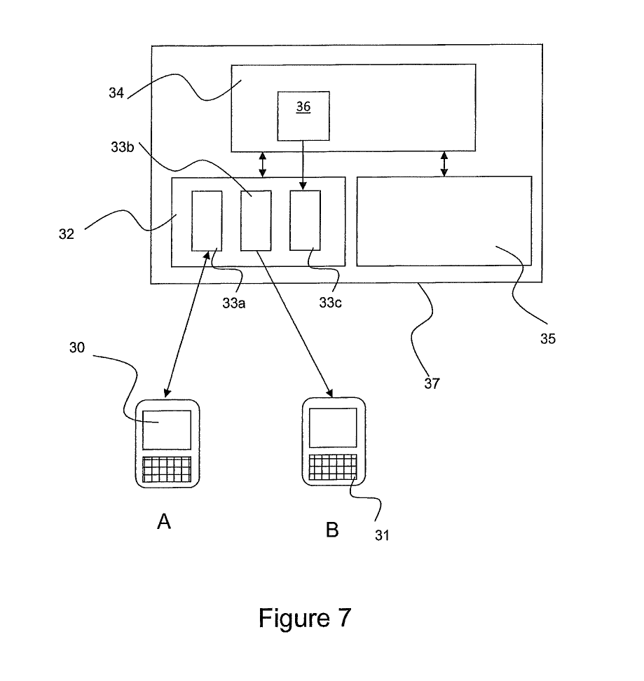

An embodiment using a conference server will now be explained with reference to FIG. 7. FIG. 7 shows two telephone devices 30 and 31, calling into a conference bridge 32. The conference call bridge 32 has a plurality of ports 33, which may be assigned to a telephone device placing a call to the conference bridge 32. Although only three ports are shown in FIG. 7, it will be appreciated that the conference bridge will have a high number of ports 33, so that it can accommodate a large number of conference calls between parties. The conference bridge 32 is controlled by a controller 34, connected to a music database 35. Controller 34 includes a music playback or streaming function 36 for receiving music from the music database 35, and playing it over an audio channel. At least one of the ports 33c in the conference bridge 32 is reserved for connecting the conference bridge 32 to the music playback or streaming function 36.

The telephone devices 30 and 31 may call the conference bridge 32 using any telephone network, such as a wired or wireless public switched telephone network (PSTN), or a packet switched network, such as the Internet using a VOIP connection.

In a preferred example, the telephone devices 31 and 32 are mobile or smart phones and the controller 34 is a server controlling a computer implemented conference bridge 32.

The music database 35 is embodied in a computer memory coupled to the server 34, and contains files encoding recordings of music. The music playback or streaming function 36 may be implemented in computer code running on the server 34.

As will be appreciated by the person skilled in the art, the combined functionality of the conference bridge 32, the controller 34, the music database 35, and the music playback or streaming function 36 may be encoded and stored entirely on a single server 37 available over the network to the telephone devices 30 and 31, or may be installed as separate elements communicating with one another over a interconnecting network.

In operation, each of the mobile telephone devices calls into the conference bridge 32 using a VOIP connection and is assigned a port 33 by the server 34. An application running on the mobile telephone device A communicates with the server 34 via the port 33 of the conference bridge 32 to exchange data between the server 34 and the mobile telephone device. The application may be downloaded to the mobile telephone specifically to provide the telephone with access to the server 34 and the music database 35, and to provide the mobile telephone with functionality to search, play and share music. The data exchanged therefore includes session information to commence a call with the server 34, and user input commands to allow the mobile telephone 30 to carry out the functions of searching, playing and sharing music.

The music database 35 stores music in logical music containers. Each user who has downloaded the application to their mobile telephone device is allocated a personal container for storing music to which they have full read/write access. Thus, they may upload music from their phone, or from any other connected computer to the container, for later playback, purchase music from the system for addition to their container, as well as editing the contents of their container, such as deleting to create more storage space.

Via the search function, the user may also have read access to other containers storing music, providing these have been made publically available by the owner of the container. In this way, the user will be able to search for music in the containers of other users who have downloaded the application, or in system maintained containers that showcase new music or provide a universally available collection of music for enjoyment.

Via the search function of the application, the user of the mobile telephone may therefore search for music available in the music database 35 and may then elect to play this over the conference bridge connection to their telephone. This may be streamed to the port 33a connected to the mobile telephone 30 directly by the server 34, or may be streamed to the port 33c in the conference bridge for a two way conference call between the mobile telephone and the music playback or streaming function 36. In this way, the user of the mobile telephone 30 can hear the streamed music as if it was a caller participating in a conference call. This function is especially useful when the user of the mobile telephone 30a chooses to share the music they are listening to with another person. This may be achieved using a share function provided by the application.

When sharing music with another person, the application allows mobile telephone 30 to call a second mobile telephone 31 (Mobile B) and have them added to the conference call. The server 34 places the call to the designated call recipient and when the call recipient answers adds the second mobile terminal to port 33b on the conference bridge 32. This creates a three way conference call between the two mobile telephone devices 30 and 31 and the third conference bridge port 33c connected to the music playback and streaming function 36. Selected music from the music database 35 is streamed via the server to the third port on the conference bridge and is audible to the two participants in the call using the mobile telephone devices.

The use of the three way conference call means that the called participant does not need to have installed the application on their mobile telephone device. Indeed the call could be placed to a standard landline telephone, not just to mobile telephones.

The application may keep track of the activity of the user of the mobile telephone 30 (Mobile A) and award points designed to encourage use of the application and enjoyment of the music. The points can be stored in an account linked to the user. For example, points may be awarded each time the user searches for music via the application, each time the user plays music via the application, and each time the user shares music with another person.

Different embodiments of the invention have been described for purely illustrative purposes. It will be appreciated that these are not intended to limit the scope of the invention defined in the claims, and that features of the different embodiments may be used in isolation or in combination with each other.

1. A computer implemented method for establishing a telephone call between a caller terminal and a call recipient terminal, in which user-selected audio or video content is transmitted during the call in addition to any spoken audio or captured video data of the caller and call recipient, comprising:
a) selecting a call recipient, and audio or video content for transmission during a call;
b) initiating a call to the selected call recipient terminal over a call network;
c) receiving data representing the caller's voice;
d) receiving audio or video data representative of the selected audio or video content;
e) preparing, at a synchroniser in the caller terminal, the received data of the caller's voice and selected audio or video content into data packets for transmission; and
f) transmitting to the call recipient the data packets of the caller's voice and selected audio or video data.

2. The method of claim 1, further comprising, in a background transmission mode, the synchroniser combining the received data of the caller's voice and selected audio or video content into packets for transmission, such that both the caller's voice and selected audio or video content are output for simultaneous playback at the call recipient terminal.

3. The method of claim 2, wherein the synchroniser selects, in dependence on the caller's voice data and the selected audio and video content, a compression scheme for the caller's voice data and a compression scheme for the selected audio or video content.

4. The method of claim 1, further comprising, in a switch transmission mode, the synchroniser processing the received data of the caller's voice and selected audio or video content into packets for transmission, such that only one output of the selected audio or video content or the caller's voice data is being played back at any time.

5. The method of claim 3, wherein the data of the caller's voice and the selected audio or video content are sent in separate data packets.

6. The method of claim 1 further comprising:
receiving at the caller terminal a user selection of a transmission mode, wherein transmission modes include a background transmission mode in which both the caller's voice and the selected audio or video content are combined for simultaneous playback, and a switch transmission mode in which the caller's voice and the selected audio or video content is interleaved for alternating playback; and
passing the user selection of the transmission mode to the synchroniser in the caller terminal.

7. The method of claim 1, further comprising transmitting control signals to the caller recipient terminal to control the initiated call between the caller terminal and the caller recipient terminal.

8. The method of claim 7, wherein the control signals cause the call recipient terminal to launch a software application.

9. The method of claim 1, further comprising receiving at the synchroniser in the caller terminal a control signal from the call recipient terminal.

10. The method of claim 7, wherein the control signals indicate a permission status over the transmission of the user selected audio or video content.

11. The method of claim 10, wherein in response to the permission status indicated by the control signals, the synchroniser in the caller terminal accepts pause or play requests for the selected audio or video content from the call recipient terminal.

12. The method of claim 10, wherein in response to the permission status indicated by the control signals, the synchroniser in the caller terminal accepts requests from the call recipient terminal for different user selected audio or video content.

13. The method of claim 1, wherein the call network is a data network.

14. The method of claim 13, wherein the data network is implements the Voice Over Internet Protocol.

15. The method of claim 1, wherein the call network is a cellular network.

16. A computer readable storage device having a computer program for establishing a telephone call between a caller terminal and a call recipient terminal, in which user-selected audio or video content is transmitted during the call in addition to any spoken audio or captured video data of the caller and call recipient, wherein when the computer program is run on a processor, the processor is caused to execute:
a) receiving a selection of a call recipient, and audio or video content for transmission during a call;
b) initiating a call to the selected call recipient terminal over a call network;
c) receiving data representing the caller's voice;
d) receiving audio or video data representative of the selected audio or video content;
e) preparing, at a synchroniser in the caller terminal, the received data of the caller's voice and selected audio or video content into data packets for transmission; and
f) transmitting to the call recipient the data packets of the caller's voice and selected audio or video data.

17. (canceled)

18. A mobile terminal on which the computer readable storage device of claim 16 is installed.

19. A mobile terminal performing the method of claim 1.

20. A computer on which the computer readable storage device of claim 16 is installed.

21. (canceled)
